(19) United States
(12) Patent Application Publication
(10) Pub. No.: US 2015/0104566 A1
(43) Pub. Date: Apr. 16, 2015

(54) MANUFACTURING METHOD OF GRAPHENE FILM

(71) Applicant: National Tsing Hua University, Hsinchu city (TW)

(72) Inventors: Wen-Chun YEN, Hsinchu city (TW); Yu-Lun CHUEH, Hsinchu City (TW)

(21) Appl. No.: 14/457,463

(22) Filed: Aug. 12, 2014

(30) Foreign Application Priority Data
Oct. 14, 2013 (TW) 102137005

(51) Int. Cl. C01B 31/02; C01B 31/04; H01B 1/04

(52) U.S. Cl. CPC C01B 31/0213; H01B 1/04; C01B 31/0453; C01B 31/0438
USPC 427/122

(57) ABSTRACT

A manufacturing method of graphene film includes the steps of: disposing a substrate in a reaction chamber including an inlet and an outlet; providing a metallic catalytic material into the reaction chamber; providing a reducing gas into the reaction chamber; raising the temperature of the reaction chamber to a deposition temperature; providing a carbon-containing gas into the reaction chamber; and generating a plurality of carbon atoms from the carbon-containing gas under the assistance of the metallic catalytic material and the atoms deposited on the substrate to form a graphene film. The manufacturing method of graphene film is capable of depositing a graphene film on the substrate and is advantageous for a transfer-free process in the following application.

### CROSS REFERENCE TO RELATED APPLICATIONS

This Non-provisional application claims priority under 35 U.S.C. §119(a) on Patent Application No(s). 102137005 filed in Taiwan, Republic of China on Oct. 14, 2013, the entire contents of which are hereby incorporated by reference.

### BACKGROUND OF THE INVENTION

1. Field of Invention

The invention relates to a manufacturing method of graphene film and, in particular, to a manufacturing method of graphene film that uses chemical vapor deposition (CVD) without the need of a solid catalysis and an additional transfer process.

2. Related Art

Graphene can be described as a one-atom thick layer of graphite. The structure of graphene is a planar sheet of sp²-bonded carbon atoms, and the atoms are densely packed in a honeycomb crystal lattice. Due to the specific structure, graphene is an excellent conductor of electricity and the electrons thereof can be transferred in a very high speed. Besides, graphene is nearly transparent and well conductive for heat. Therefore, it has been widely applied to many fields, such as semiconductor, touch panel and solar cell. Especially, graphene has high flexibility and low reflectance for the application of transparent electrodes, so it is the first choice for the flexible electronic material currently.

The conventional art for manufacturing graphene includes mechanical exfoliation, epitaxial growth, and redox method for reducing graphene oxide (GO). Although the mechanical exfoliation and the epitaxial growth can produce high-quality graphene, the mechanical exfoliation can not produce a large-area graphene film (with the area less than 1 cm² in substance). Moreover, the process of epitaxial growth needs to be performed under the condition of ultra-high vacuum and high temperature (below 10-7 torr and above 1400° C.) and the produced silicon carbide can not be removed by etching. Therefore, the product of a larger area is also accompanied by the higher cost. Although the epitaxial growth can produce a large-area graphene film, the catalysis in this method needs to be performed on a specific substrate so that an additional transfer process is required to transfer graphene onto target substrate for device. Many defects will occur due to an additional transfer process and the quality of graphene will be thus degraded. Besides, the size of the product is also determined and limited by the size of the specific substrate. As to the redox method, it first oxidates a graphite and then uses a high-temperature reduction to rearrange the carbon atoms into the graphene lattice having the property of transmitting electricity. However, the oxidation process will cause damage to the graphene lattice, and not all the oxidated graphene can be effectively reduced. The production and application of graphene will be limited by the all shortages of the above-mentioned methods.

The chemical vapor deposition (CVD) currently regarded as the mainstream is to grow a graphene film on a temporary metallic substrate, such as a copper or nickel foil substrate. The carbon for the process comes from various carbon-containing gas, such as methane or ethylene. This kind of method is favorable to produce a large-area graphene with good quality. However, the method of CVD for producing graphene also has some shortages as follows:

(1) since the solid metal foil disposed on the substrate forms the range for catalyzing the growth, the production will be limited by the quality and area of the metal foil, so if the graphene film needs to be produced as a continuous even film, the metal foil also requires a high evenness, for avoiding the deformation when the graphene grows along the metal foil;

(2) the metal foil costs a lot, and the copper nickel foil for catalyzing the graphene is required for the purity of 99.9%˜99.99%; and

(3) various electronic devices, such as field effect transistors, can not be directly formed on the metal foil, so an additional transfer process is needed to transfer the graphene film to an insulating substrate. This transfer process involves the steps of forming and removing a protection layer, etching the foil, and mechanical transfer, and these steps will cause the transferred graphene a lot of damages, such as the remaining of the etchant, wrinkles and the remaining of the protection layer, and therefore the efficiency of the device will be degraded a lot.

Although some researches, such as plasma enhanced chemical vapor deposition (PECVD) or back-side segregation, have been developed for a transfer-free process of the graphene film, the graphene produced by PECVD has a extremely bad quality, because the carbon-containing gas is cracked directly by the plasma and thus the crystal can not grow naturally. The back-side segregation still uses solid metal material for the catalysis, so it is unavoidable to use an etchant to remove the solid metal material.

Therefore, it is an important subject to provide a manufacturing method of graphene film that can be performed on the basis of CVD and without an additional transfer process so as to deposit a high-quality, more even and large-area graphene film on various kinds of substrates.

### SUMMARY OF THE INVENTION

In view of the foregoing subject, an objective of the invention is to provide a manufacturing method of graphene film that can be performed on the basis of CVD and without an additional transfer process so as to deposit a high-quality, more even and large-area graphene film on various kinds of substrates.

To achieve the above objective, a manufacturing method of graphene film according to the invention includes the steps of: disposing a substrate in a reaction chamber including an inlet and an outlet; providing a metallic catalytic material into the reaction chamber; providing a reducing gas into the reaction chamber; raising the temperature of the reaction chamber to a deposition temperature; providing a carbon-containing gas into the reaction chamber; and generating a plurality of carbon atoms from the carbon-containing gas under the assistance of the metallic catalytic material and the atoms deposited on the substrate to form a graphene film.

In one embodiment, the substrate is endurable for at least 950° C.

In one embodiment, before providing the carbon-containing gas, the manufacturing method further comprises a step of adjusting the pressure of the reaction chamber to 10 torr˜660 torr.

In one embodiment, the deposition temperature is 950° C.˜1200° C.

In one embodiment, the metallic catalytic material includes nickel, cobalt or iron.

In one embodiment, the substrate includes insulating material, metal material, semiconductor material, or their any combination.

In one embodiment, the reducing gas includes hydrogen or argon.

In one embodiment, the carbon-containing gas includes alkyl group, acetaldehyde, ethane, acetylene or their any combination, each of which has the chemical formula of 1 to 5 carbon atoms.

In one embodiment, the manufacturing method is implemented according to a chemical vapor deposition (CVD) process.

As mentioned above, in the manufacturing method of graphene film of the invention, the carbon-containing gas continuously fed into the reaction chamber can be cracked to generate carbon atoms under the assistance of the vaporized metallic gas coming from the metallic catalytic material, and the carbon atoms can be directly deposited on the substrate in the reaction chamber to form a large-area graphene film by controlling the deposition temperature and reaction pressure. In comparison with the prior art where an additional transfer process needs to be performed to transfer the graphene film to the desired substrate and the graphene film is thus damaged during the transfer process, the graphene film produced by the invention needn't undergo any transfer process, so the method of the invention is capable of producing the high-quality graphene film and increasing the practicability.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow chart of a manufacturing method of graphene film according to a preferred embodiment of the invention;

FIG. 2 is a schematic diagram of a reaction apparatus applied to the manufacturing method of graphene film shown in FIG. 1;

FIG. 3 is a schematic diagram of the reaction mechanism of the manufacturing method of graphene film in FIG. 1;

FIG. 4 is a schematic diagram of the Raman spectrum of the graphene film produced by the manufacturing method of graphene film in FIG. 1;

FIG. 5 is a schematic diagram of an energy scattering spectrum of the graphene film produced by the manufacturing method of graphene film in FIG. 1;

FIG. 6 is a schematic diagram showing the peak ratio of G/2D of the graphene film produced by the manufacturing method of graphene film in FIG. 1;

FIG. 7 is a schematic diagram showing the electrical measurement of the graphene film produced by the manufacturing method of graphene film in FIG. 1;

FIG. 8 is a schematic diagram of the Raman spectrum of the graphene film produced by the manufacturing method of graphene film in FIG. 1;

FIGS. 9A and 9B are schematic diagrams of the Raman spectrum of the graphene film produced by the manufacturing method of graphene film in FIG. 1;

FIG. 10 is a schematic diagram of the energy spectrum of the graphene film produced by the manufacturing method of graphene film in FIG. 1;

FIG. 11 is a schematic diagram showing the transmittances of the graphene films produced by the manufacturing method of graphene film in FIG. 1 under different deposition temperatures; and

FIG. 12 is a schematic diagram showing the transmittance of the graphene films in FIG. 11 when illuminated by the light of wavelength of 550 nm.

### DETAILED DESCRIPTION OF THE INVENTION

The present invention will be apparent from the following detailed description, which proceeds with reference to the accompanying drawings, wherein the same references relate to the same elements.

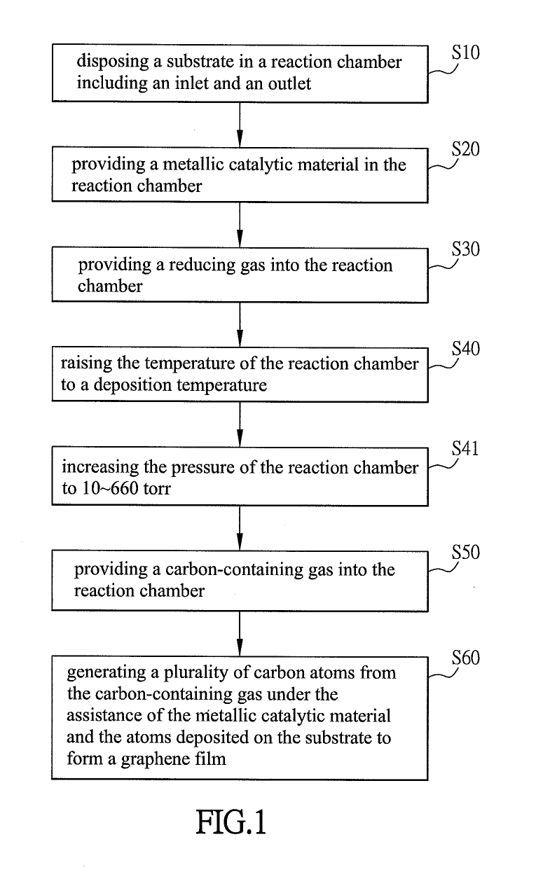

FIG. 1 is a flow chart of a manufacturing method of graphene film according to a preferred embodiment of the invention. As shown in FIG. 1, the manufacturing method of graphene film of this embodiment includes the steps of: disposing a substrate in a reaction chamber including an inlet and an outlet (S10); providing a metallic catalytic material in the reaction chamber (S20); providing a reducing gas into the reaction chamber (S30); raising the temperature of the reaction chamber to a deposition temperature (S40); providing a carbon-containing gas into the reaction chamber (S50); and generating a plurality of carbon atoms from the carbon-containing gas under the assistance of the metallic catalytic material and the atoms deposited on the substrate to form a graphene film (S60). Herein, the so called graphene film includes a single layer or a plurality of layers. The graphene film of a single layer has a thickness about the thickness of a carbon atom, and the graphene film including a plurality of layers can be analogized accordingly. To be noted, the number of the layers and the thickness of the graphene film can be varied according to the applications, and the invention is not limited thereto.

In order to clarify the details of the steps of the method, the devices, material and conditions used in this embodiment will be first illustrated as below, and how to use the devices, material and conditions to perform the method will be illustrated subsequently. To be noted, however, the embodiments as below are just for the illustration but not for limiting the scope of the invention.

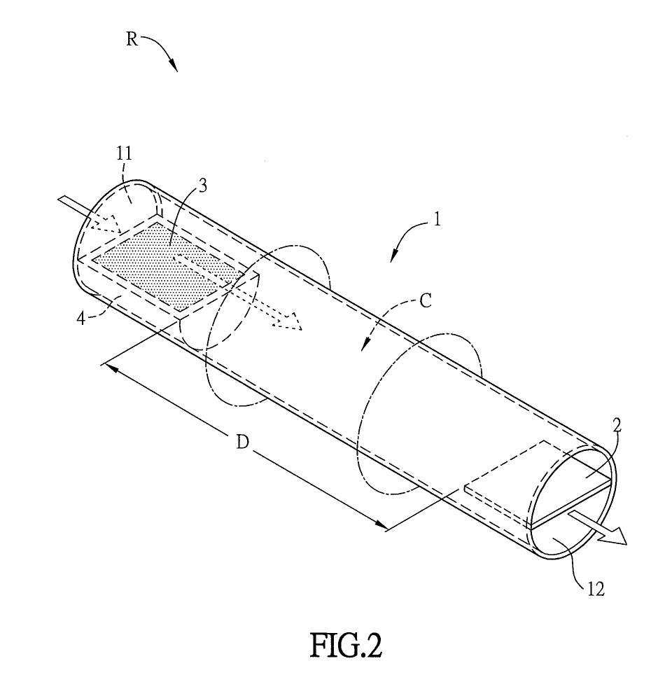

FIG. 2 is a schematic diagram of a reaction apparatus applied to the manufacturing method of graphene film shown in FIG. 1. As shown in FIGS. 1 and 2, the reaction apparatus R mainly includes a reaction chamber 1, which is a high-temperature furnace tube in a practical application and well known by those skilled in the art. Thereby, the details of the method can be achieved by the existing apparatus and there is no need to develop other apparatuses, and therefore the method of this invention is compatible to the existing process and apparatus.

The reaction chamber 1 includes an inlet 11 and an outlet 12. The inlet 11 and the outlet 12 can be disposed on the opposite sides of the reaction chamber 1, and a reaction channel C is formed within the reaction chamber 1. In the steps S10 and S20, a substrate 2 and a metallic catalytic material 3 are disposed in the reaction chamber 1. For example, the substrate 2 is disposed on the side of the reaction chamber 1 near the outlet 12 while the metallic catalytic material 3 is disposed in a crucible 4 and on the side of the reaction chamber 1 near the inlet 11. In this embodiment, the distance between the crucible 4 and the substrate 2 is defined as a disposition distance D. For achieving an effective deposition, the disposition distance D is favorably between 5 cm and 80 cm. To be noted, the magnitude of the disposition distance D will not affect the produced graphene film, but the detailed result will be illustrated in the following description and omitted here.

Accordingly, in a practical application, the metallic catalytic material 3 is put in the crucible 4 when they are outside the reaction chamber 1. The crucible 4 of this embodiment is an aluminum monoxide crucible for example, but the invention is not limited thereto.

The substrate 2 contains an insulating material, a metal material, a semiconductor material, or their any combination. The metallic catalytic material 3 includes nickel, cobalt or iron. In this embodiment, the substrate 2 is a silica (quartz) substrate, and the metallic catalytic material 3 is a nickel ingot, for example.

When the substrate 2 and the metallic catalytic material 3 are set within the reaction chamber 1, the pressure of the reaction chamber 1 is decreased to 1˜9*10⁻² torr. In other words, the reaction chamber 1 is made vacuum by the extraction for providing other gas into the reaction chamber 1.

In the step S30 of this embodiment, a reducing gas (not shown) is added into the reaction chamber 1. In detail, the reducing gas is provided into the chamber while the airflow or gas reactant in the reaction channel C is forced to flow from the inlet 11 to the outlet 12. In a practical application, the reducing gas can include hydrogen or argon.

Then, the step S40 is performed to raise the temperature of the reaction chamber 1 to a deposition temperature. In a practical application, the deposition temperature is between 950° C. and 1200° C., and favorably above 950° C. and below 1200° C. More favorably, the deposition temperature is 1075° C.˜1125° C. Meanwhile, a step S40 is performed to adjust the pressure of the reaction chamber 1 to a reaction pressure, which is 10 torr˜660 torr in this embodiment. To be noted, the deposition temperature and the reaction pressure can be adjusted according to other conditions (e.g. the desired deposition thickness), and they can be the combination of any two values within the any above-mentioned ranges.

Accordingly, the substrate 2 of this embodiment can endure the temperature of at least 950° C. However, the temperature that the substrate 2 can endure is determined according to the deposition temperature. If the deposition temperature is 1200° C., the temperature that the substrate 2 can endure is at least 1200° C.

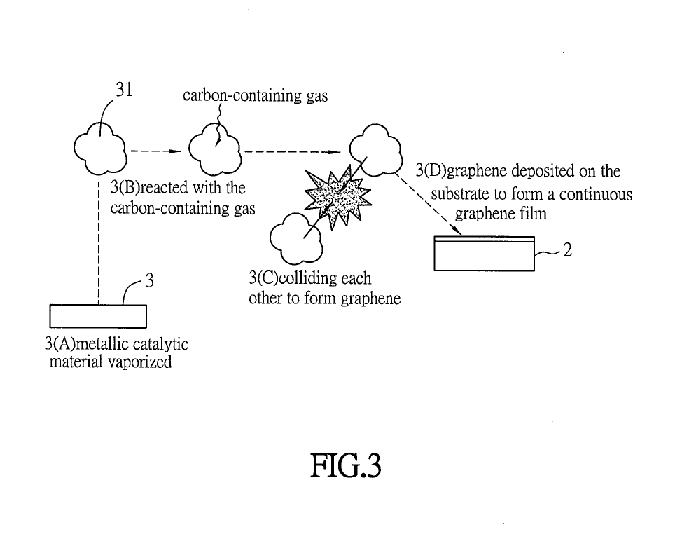

After the deposition temperature is achieved, the step S50 is performed to provide a carbon-containing gas into the reaction chamber 1, and to be noted, meanwhile, the reducing gas is stilled provided into the reaction chamber 1. Then, the metallic catalytic material 3 and the carbon-containing gas react together. The detailed reaction can be known by referring to FIG. 3, which is a schematic diagram of the reaction mechanism of the manufacturing method of graphene film in FIG. 1. As shown in FIGS. 1 to 3, when the reaction chamber 1 is raised gradually to the deposition temperature that doesn't arrive at the melting point of the metallic catalytic material 3, a part of the metallic catalytic material 3 will be vaporized to become the gaseous metallic catalytic material 31 (as shown in FIG. 3(A)). The gaseous metallic catalytic material 31 will help the reaction of the carbon-containing gas (as shown in FIG. 3(B)), so that the carbon-containing gas is cracked to generate carbon atoms. Then, by controlling the flow rate, flow flux and flow distance of the reducing gas and the carbon-containing gas, the carbon atoms can have enough time to collide each other at the vapor state and bond into a hexagonal form to form the graphene (as shown in FIG. 3(C)). After the graphene is formed, it will be deposited naturally on the substrate 2 due to the gravity to form the graphene film (as shown in FIG. 3(D)).

The carbon-containing gas serving as the carbon source of the graphene film needs to react under a high-temperature condition, so the carbon-containing gas is favorably a carbon-containing compound, for example, including alkyl group, acetaldehyde, ethane, acetylene or their any combination, each of which has the chemical formula of 1 to 5 carbon atoms. However, the invention is not limited thereto, and other compounds capable of providing carbon atoms also can be properly used.

Moreover, the step of raising the reaction chamber 1 to the deposition temperature also includes stabilizing the reaction chamber 1 substantially at the deposition temperature. To be noted, the said “substantially” means the reaction chamber 1 may not be exactly stabilized at the deposition temperature during a certain period, but some allowable error due to some special, theoretical or practical conditions can be comprehended.

The method in this embodiment can use the traditional CVD process and apparatus, and besides, the graphene film is directly deposited on the insulating substrate which could be made into logic device directly, so that an additional transfer process to remove the graphene film is unnecessary. Accordingly, in comparison with the prior art of using the CVD process to produce graphene, the invention is characterized by the transfer-free process.

The below including some embodiments is related to the details of the main steps of the manufacturing method of graphene film of the invention and to the effectiveness provided by controlling some conditions. To be noted, the following illustration is just about the practical realization for those skilled in the art, but not for limiting the scope of the invention.

In this embodiment, as shown in FIG. 2, the nickel ingot with the purity of 99%˜99.99% is used as the metallic catalytic material 3, and the disposition distance D between the crucible 4 and the substrate 2 is 5 cm˜80 cm. The magnitude of the disposition distance D will not substantially affect the result of this embodiment. After the reaction chamber 1 is made nearly vacuum with the pressure of 10⁻² torr, the reducing gas (hydrogen of 20 sccm and argon of 100 sccm for example) is provided into the reaction chamber 1. Then, the reaction chamber is raised to the deposition temperature of 1100° C. in a temperature raising rate of 25° C./min, and the reaction pressure is adjusted to 60 torr. Then, the carbon-containing gas (methane for example) is provided into the reaction chamber 1, and the reaction chamber 1 is set to the deposition temperature (1100° C.) for five minutes. After the above-mentioned steps are finished, the provision of the carbon-containing gas and the reducing gas (hydrogen) can be stopped. Then, after the whole reaction apparatus R is cooled to the room temperature, the provision of another reducing gas (argon) can be stopped.

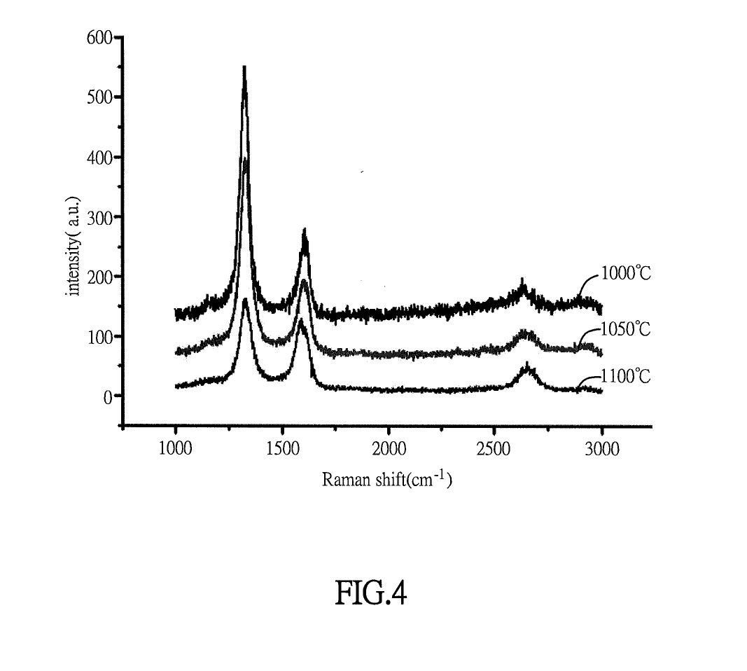

The graphene film on the substrate 2 manufactured by the above-mentioned method is analyzed by the Raman spectrum, including the peak point, peak width and peak variation, so the completeness, evenness, number of layers, and layer stack type of the graphene film can be effectively determined by the results as shown in FIGS. 4 to 8, 9A, 9B, 10 to 12.

To be noted, in order to show the results from different deposition temperatures, three different deposition temperatures (1000° C., 1050° C., 1100° C.) are applied to some of the embodiments to provide the results for comparison.

FIG. 4 is a schematic diagram of the Raman spectrum of the graphene film produced by the manufacturing method of graphene film in FIG. 1. As shown in FIG. 4, the graphene films produced under the deposition temperatures of 1000° C., 1050° C. and 1100° C. mainly have three obvious peaks including 1350 cm⁻¹ (D peak), 1583 cm⁻¹ (G peak) and 2680 cm⁻¹ (2D peak). The D peak, G peak and 2D peak are the most important characteristic peaks of graphene. From FIG. 4, the D peak is higher than the other peaks, which indicates the graphene film formed by the deposition method has smaller crystalline particles and a higher density.

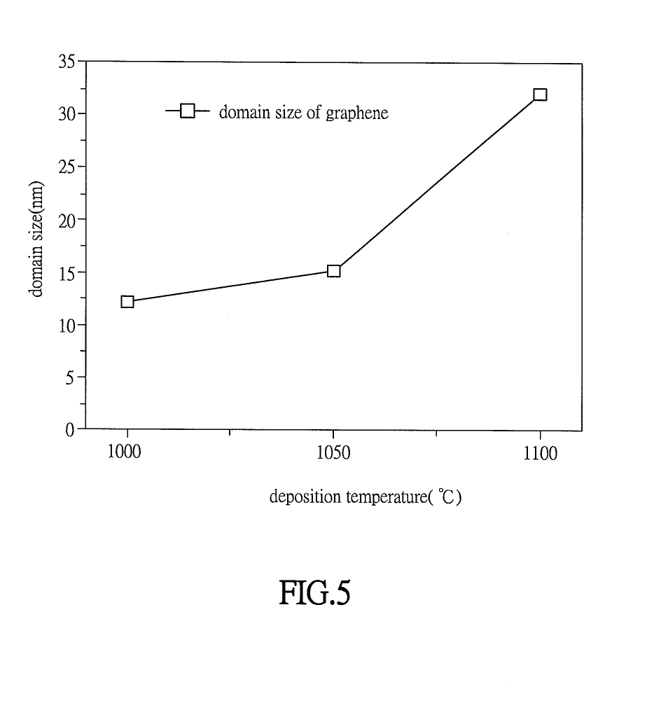

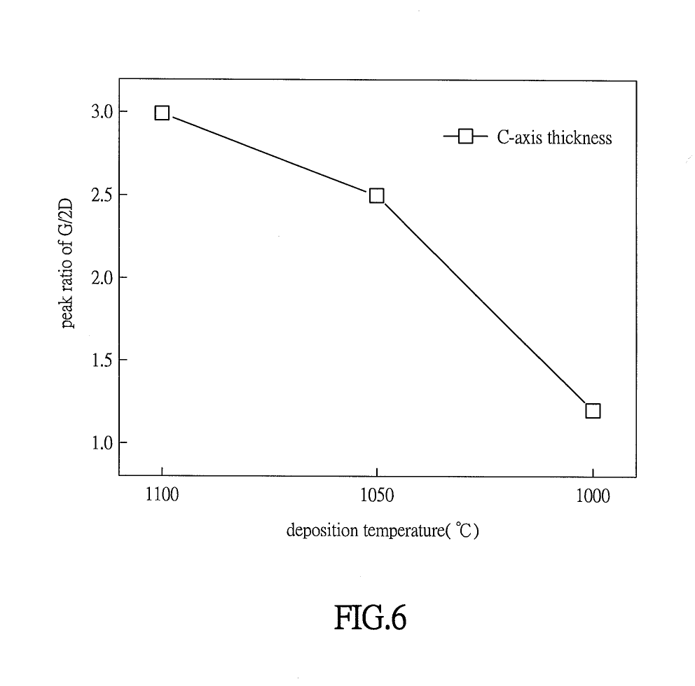

FIG. 5 is a schematic diagram of an energy scattering spectrum of the graphene film produced by the manufacturing method of graphene film in FIG. 1, and FIG. 6 is a schematic diagram showing the peak ratio of G/2D of the graphene film produced by the manufacturing method of graphene film in FIG. 1. By taking the deposition temperature of 1100° C. as an example, the domain size of the graphene film of this embodiment is about 32 nm (as shown in FIG. 5). In comparison with the domain size of about 2 nm produced by the conventional ECRCVD, this invention is capable of forming the graphene film of a larger domain size, and the larger domain size indicates a better electrical conductivity.

Besides, the signal intensity ratios of 2D peak to G peak of the multi-layer graphene film and the single graphene film are obviously different. The signal intensity of 2D peak of the multi-layer graphene film is less than that of the single-layer graphene film, and the signal intensity of 2D peak of the single-layer graphene film is greater than the signal intensity of G peak of the single-layer graphene film. Therefore, as shown FIG. 6, the method with the deposition temperature of 1100° C. can produce the graphene film having a multi-layer structure, which is favorable for the application of forming the material of high metallic property. To be noted, the said multi-layer structure is just for the exemplificative illustration. In a practical application, this method is also capable of producing a single-layer graphene film, which is favorable for the application of forming the material of high semiconductor property. However, the invention is not limited thereto.

As shown in FIGS. 5 and 6, by comparing the graphene films produced under the deposition temperatures of 1000° C., 1050° C. and 1100° C., the domain size and the peak ratio of G/2D will both rise with the rising deposition temperature. The increment of the peak ratio of G/2D indicates the increment of the C-axis (out of plane) thickness of the graphene film and relatively more regular C-axis lattice arrangement.

To be noted, in the Raman spectrum analysis, the full width at half maximum (FWHM) of 2D peak of the graphene film produced by the method is 40˜60/cm.

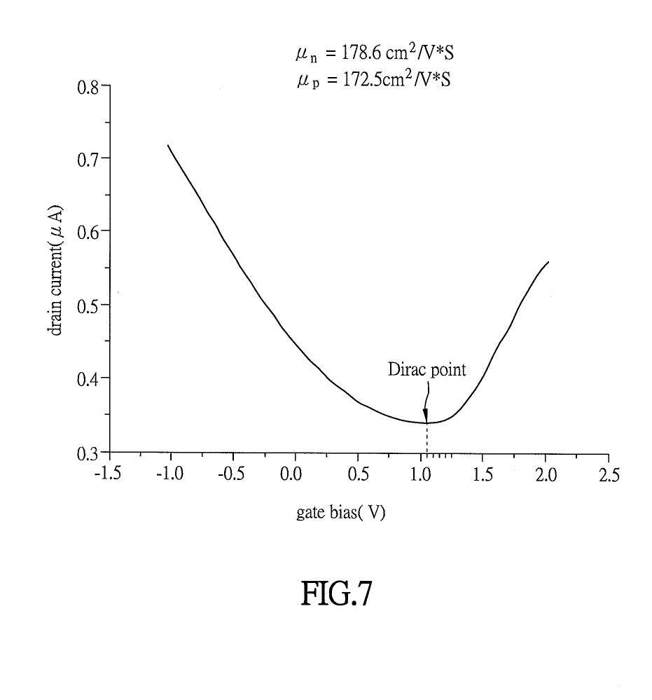

FIG. 7 is a schematic diagram showing the electrical measurement of the graphene film produced by the manufacturing method of graphene film in FIG. 1. As shown in FIG. 7, from the measuring result of the field effect transistor, the produced graphene film has a slightly p-type doping property, the Dirac point shift is about 1.1V, and the electron mobility (μn) is 178.6 cm²N*S close to the hole mobility (μp) of 172.5 cm²/V*S, showing the typical carrier mobility property of graphene. Accordingly, the graphene film still has a considerable semi-metal property, which indicates the graphene film of the invention has considerable potential when applied in the transparent conductive film or field effect transistor.

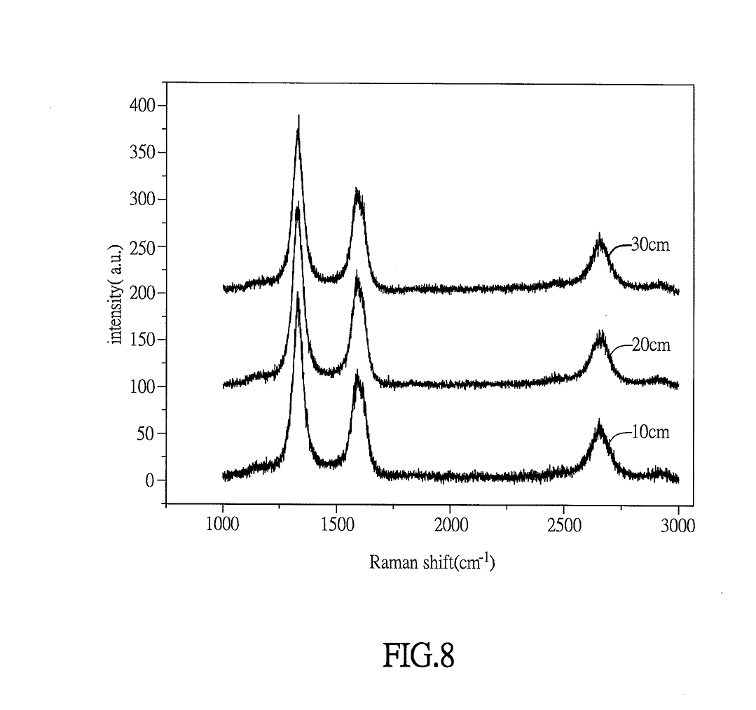

In order to verify that the graphene film produced by the manufacturing method of graphene film of the invention will not be affected by the disposition distance D between the crucible 4 and the substrate 2, the Raman spectrums are measured respectively in the cases of the graphene films produced under the disposition distances D of 10 cm, 20 cm and 30 cm with the deposition temperature of 1100° C. and the reaction pressure of 60 torr. The results are shown in FIG. 8.

FIG. 8 is a schematic diagram of the Raman spectrum of the graphene film produced by the manufacturing method of graphene film in FIG. 1. As shown in FIG. 8, the graphene films produced under the disposition distances D of 10 cm, 20 cm and 30 cm mainly have three obvious peaks including 1350 cm⁻¹ (D peak), 1583 cm⁻¹ (G peak) and 2680 cm⁻¹ (2D peak). The D peak, G peak and 2D peak are the most important characteristic peaks of graphene. Accordingly, the disposition distance D between the crucible 4 and the substrate 2 doesn't have appreciable impact on the deposition quality. Thereby, when using a large-area substrate, the manufacturing method of graphene film of the invention is capable of producing a large-area graphene film on the substrate.

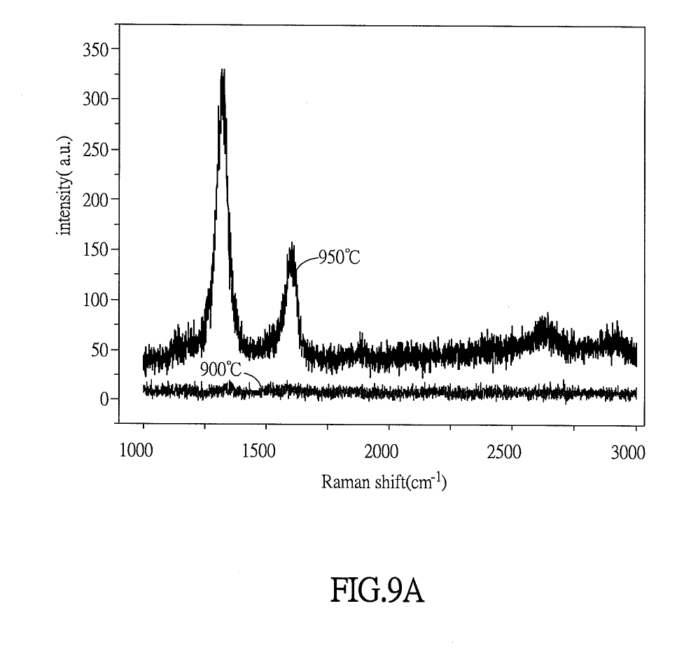

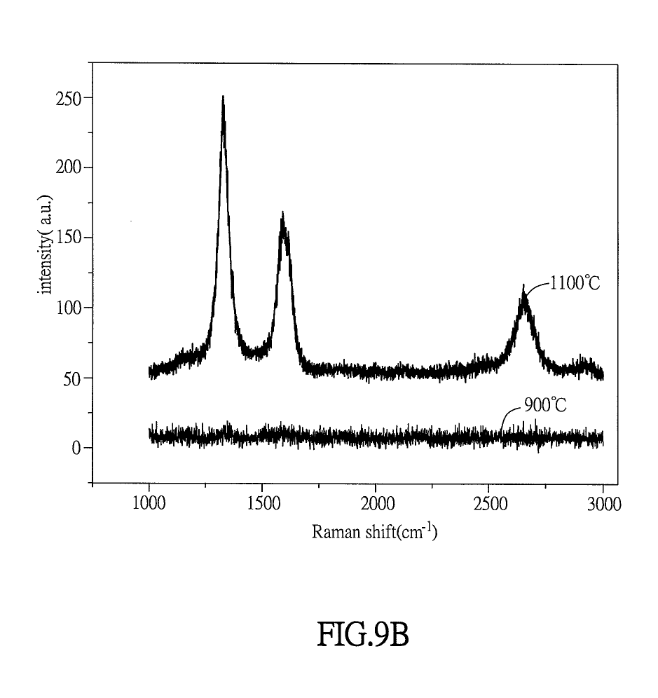

FIGS. 9A and 9B are schematic diagrams of the Raman spectrum of the graphene film produced by the manufacturing method of graphene film in FIG. 1. In this embodiment, the results of the deposition under different deposition temperatures of 900° C., 950° C. and 1100° C. are compared. As shown in FIGS. 9A and 9B, it is obvious that the method with the deposition temperatures of 900° C. can not form the deposited graphene film but the method with the deposition temperatures of 950° C. and 1100° C. can form the deposited graphene film having three obvious peaks of 1350 cm⁻¹ (D peak), 1583 cm⁻¹ (G peak) and 2680 cm⁻¹ (2D peak). The D peak, G peak and 2D peak are the most important characteristic peaks of graphene. According to this verification, the method of the invention is capable of producing a better graphene film.

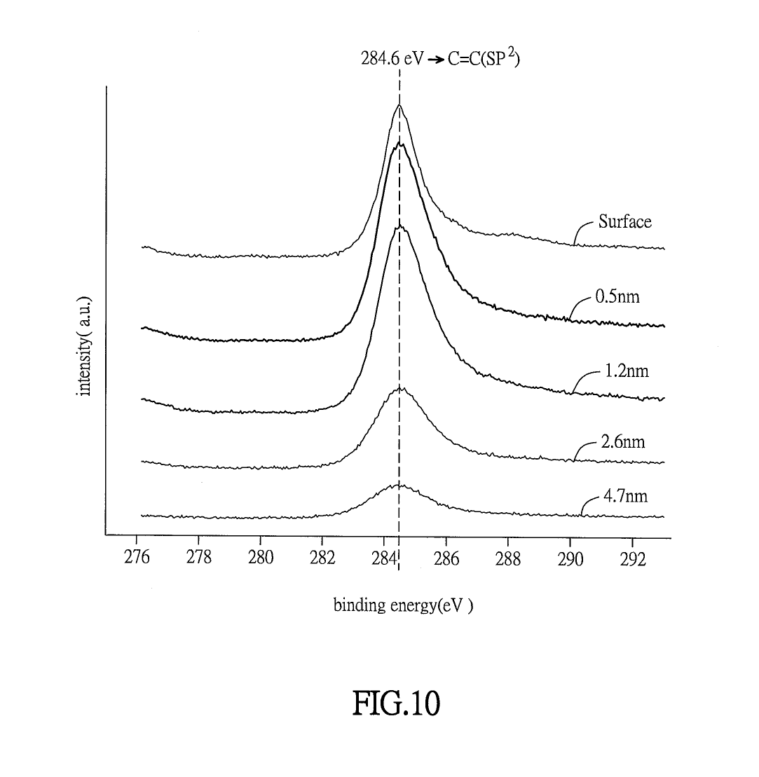

Furthermore, the possible bonding form of the graphene can be predicted by using an x-ray photoelectron spectrometer (XPS) to detect the bonding situation between carbon and nitrogen. FIG. 10 is a schematic diagram of the energy spectrum of the graphene film produced by the manufacturing method of graphene film in FIG. 1. As shown in FIG. 10, the binding energy of 284.6 eV shown in the carbon bonding spectrum of the graphene film represents the C═C (sp²) bonding. From FIG. 10, it can be known that no chemical bonding exists between the graphene film and the substrate, which indicates the graphene film of the invention is formed by the deposition using the CVD process but not formed by the crystalline growth.

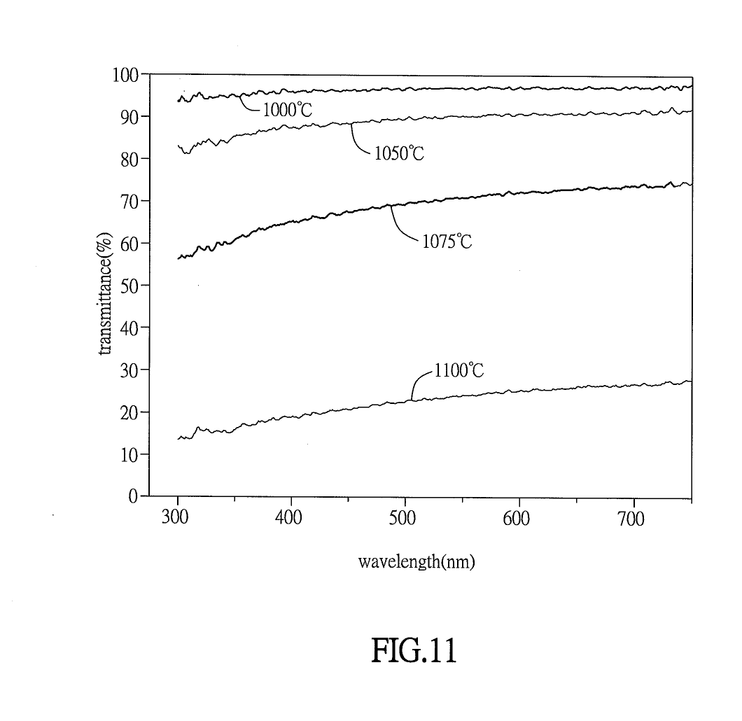

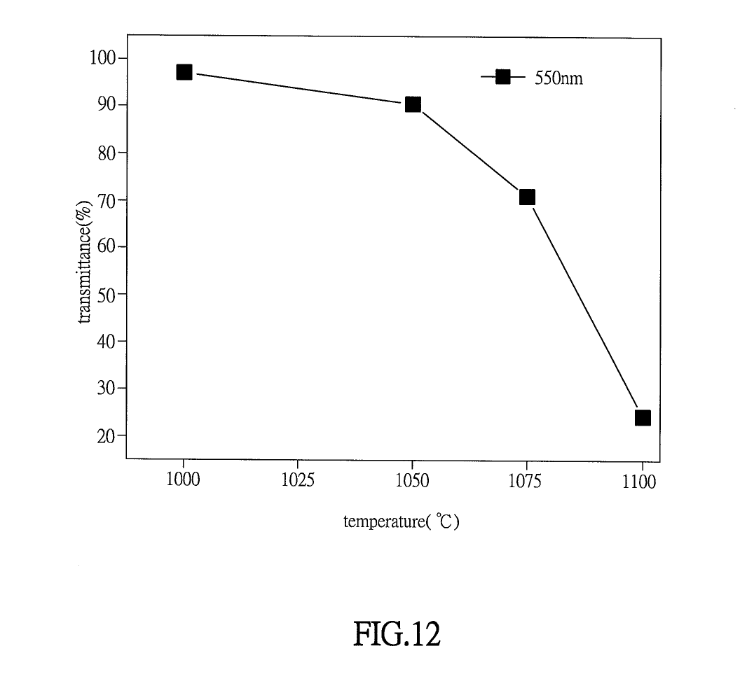

After the graphene film is formed, it can be applied to the manufacturing of the transparent electrode. In other words, the produced graphene film is provided with a high transmittance. FIG. 11 is a schematic diagram showing the transmittances of the graphene films produced by the manufacturing method of graphene film in FIG. 1 under different deposition temperatures, and FIG. 12 is a schematic diagram showing the transmittance of the graphene films in FIG. 11 when illuminated by the light of wavelength of 550 nm. Obviously, when the deposition temperature rises, the transmittance descends. In other words, the graphene film can be produced by the method of the invention using the desired deposition temperature according to the application and the desired transmittance to achieve the desired purpose.

In summary, in the manufacturing method of graphene film of the invention, the carbon-containing gas continuously fed into the reaction chamber can be cracked to generate carbon atoms under the assistance of the vaporized metallic gas coming from the metallic catalytic material, and the carbon atoms can be directly deposited on the substrate in the reaction chamber to form a large-area graphene film by controlling the deposition temperature and reaction pressure. In comparison with the prior art where an additional transfer process needs to be performed to transfer the graphene film to the desired substrate and the graphene film is thus damaged during the transfer process, the graphene film produced by the invention needn't undergo any transfer process, so the method of the invention is capable of producing the high-quality graphene film and increasing the practicability.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of graphene film, comprising steps of:
disposing a substrate in a reaction chamber including an inlet and an outlet;
providing a metallic catalytic material in the reaction chamber;
providing a reducing gas into the reaction chamber;
raising the temperature of the reaction chamber to a deposition temperature;
providing a carbon-containing gas into the reaction chamber; and
generating a plurality of carbon atoms from the carbon-containing gas under the assistance of the metallic catalytic material and the atoms deposited on the substrate to form a graphene film.

2. The manufacturing method as recited in claim 1, wherein the substrate is endurable for at least 950° C.

3. The manufacturing method as recited in claim 1, before providing the carbon-containing gas, further comprising a step of:
adjusting the pressure of the reaction chamber to 10 torr˜660 torr.

4. The manufacturing method as recited in claim 1, wherein the deposition temperature is 950° C.˜1200° C.

5. The manufacturing method as recited in claim 1, wherein the metallic catalytic material includes nickel, cobalt or iron.

6. The manufacturing method as recited in claim 1, wherein the substrate includes insulating material, metal material, semiconductor material, or their any combination.

7. The manufacturing method as recited in claim 1, wherein the reducing gas includes hydrogen or argon.

8. The manufacturing method as recited in claim 1, wherein the carbon-containing gas includes alkyl group, acetaldehyde, ethane, acetylene or their any combination, each of which has the chemical formula of 1 to 5 carbon atoms.

9. The manufacturing method as recited in claim 1, which is implemented according to a chemical vapor deposition (CVD) process.
